(19) United States
(12) Patent Application Publication
(10) Pub. No.: US 2025/0390876 A1
(43) Pub. Date: Dec. 25, 2025

(54) SYSTEMS AND METHODS FOR IDENTIFYING RISKY TRANSACTIONS USING MULTIPLE LOCATION DATA POINTS

(71) Applicant: T-Mobile Innovations LLC, Overland Park, KS (US)

(72) Inventors: Ahmad AL ACCAD, Renton, WA (US); Michael James ENGAN, Bellevue, WA (US); Anandajothi MUTTAYANE, Renton, WA (US); Terry SCHEIHING, Redmond, WA (US)

(21) Appl. No.: 18/748,451

(22) Filed: Jun. 20, 2024

(51) Int. Cl. G06Q 20/40

(52) U.S. Cl. CPC G06Q 20/4016; G06Q 20/4015

(57) ABSTRACT

Systems and methods are provided for identifying risky transactions using multiple location data points. Locations of the wireless device, wireless provider's store, dominant location of the wireless device, home location of the wireless device, and the person requesting a transaction with the wireless account of the wireless device may be determined. Using selected distances between these various location data points, a risk score is calculated. A high risk score might trigger the need for secondary authorization for the transaction. An even higher score might lead to the denial of the transaction.

### TECHNICAL BACKGROUND

Wireless subscriber accounts are increasingly becoming sought after targets of cyber-criminals. The accounts can be bought and sold, used to make large fraudulent purchases, used as vectors to target other user accounts, and even used in other criminal activities. There are many ways in which an account may be taken over, including so-called SIM swap schemes. Reducing the instances of fraudulent use of customer accounts leads to better customer experience and saves time and money for the wireless providers and their customers.

### OVERVIEW

Examples described herein include systems and methods for identifying risky transactions using multiple location data points. An exemplary method includes receiving a request to perform a transaction with an account of a wireless device. The method further includes determining a risk score based in part on at least two of the following: a distance between a current location of the wireless device and a location of a person requesting the transaction, a distance between the current location of the wireless device and a physical store location of a wireless provider for the wireless device, a distance between the current location of the wireless device and a home location of the wireless device, a distance between the current location of the wireless device and a dominant location of the wireless device, a distance between the dominant location of the wireless device and the physical store location, and a distance between the home location and the physical store location. The method further includes in response to the risk score being above a first risk score threshold, requiring secondary authorization to complete the requested transaction.

Another exemplary embodiment includes a system with a transaction authentication server, including at least one processor configured for executing instructions to perform operations. The operations include receiving a request to perform a transaction with an account of a wireless device. The operations further include determining a risk score based in part on at least two of the following: a distance between a current location of the wireless device and a location of a person requesting the transaction, a distance between the current location of the wireless device and a physical store location of a wireless provider for the wireless device, a distance between the current location of the wireless device and a home location of the wireless device, a distance between the current location of the wireless device and a dominant location of the wireless device, a distance between the dominant location of the wireless device and the physical store location, and a distance between the home location and the physical store location. The operations further include in response to the risk score being above a first risk score threshold, requiring secondary authorization to complete the requested transaction.

Another exemplary method includes receiving a request to perform an account transaction with an account for a wireless device. The method further includes determining a dominant location of the wireless device by querying a database comprising historical location data for the wireless device. The method further includes determining a home location of the wireless device by querying an account database for a home address associated with the account for the wireless device. The method further includes determining a current location of the wireless device. The method further includes determining a risk score based in part on at least two of the following: a distance between a current location of the wireless device and a location of a person requesting the transaction, a distance between the current location of the wireless device and a physical store location of a wireless provider for the wireless device, a distance between the current location of the wireless device and a home location of the wireless device, a distance between the current location of the wireless device and a dominant location of the wireless device, a distance between the dominant location of the wireless device and the physical store location, and a distance between the home location and the physical store location. The method further includes in response to the risk score being above a first risk score threshold, requiring secondary authorization to complete the requested transaction.

### BRIEF DESCRIPTION OF DRAWINGS

These and other more detailed and specific features of various embodiments are more fully disclosed in the following description, reference being had to the accompanying drawings, in which:

FIG. 1 illustrates an example system for wireless communication in accordance with various aspects of the present disclosure;

FIG. 2 illustrates an exemplary operating environment for identifying risky transactions using multiple location data points in accordance with various aspects of the present disclosure;

FIG. 3 illustrates an example processing node in accordance with various aspects of the present disclosure;

FIG. 4 illustrates an example process flow for identifying risky transactions using multiple location data points; and

FIG. 5 illustrates an example process flow for identifying risky transactions using multiple location data points.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

Access to a wireless account may be made available to the account holder via the wireless provider's website or customer service portal, in the wireless provider's store locations or via a phone call to the wireless provider's customer care number. In a store, the person requesting access to the account is expected to have the wireless device in question, unless it is lost, and to answer security questions, such as the last four digits of the account holder's social security number, for example. Similarly, customer care representatives will ask security questions before permitting access to the wireless account.

For website access, the account holder is required to login to their account to gain access to their account details, usually by way of a username and password. Once authenticated, the account holder can perform many different functions such as changing information of the account, adding or removing devices or lines, ordering or activating new equipment, changing a SIM card for a device, or changing service levels, for example. There are also many functions that are common to other types of online accounts as well, such as changing the account's password or the account holder's contact information including mailing address or email address.

Short Messaging Service (SMS) One-Time Passwords (OTPs) are a common method of Two Factor Authentication (2FA) for online accounts. For example, banks often send an OTP to the registered mobile phone number when a user of their website or app tries to login. The user is then required to enter the OTP to complete the authentication process.

Online accounts, whether for wireless subscribers or otherwise, also have mechanisms for when an account holder forgets their username or password. Often this is presented at the login page as a link for resetting a forgotten password. The user will then be presented with options to verify the person requesting the password reset. This can be done by having the provider send an email to the email address on record for the account, having the user answer security questions, using an external authenticator application, or via an OTP sent via SMS to the account holder's mobile phone. Each of those methods may have different levels of convenience and vulnerability.

One increasingly common attack on wireless accounts and users is a SIM swap attack. This type of attack occurs when a bad actor impersonates a victim to the victim's wireless provider in order to hijack the mobile phone number of the user. For example, the bad actor could call the victim's wireless provider's customer care line impersonating the victim and say that they lost their mobile phone. The bad actor then convinces the customer care representative to activate their phone as the replacement for the “lost” phone. The bad actor's phone now has the mobile phone number of the victim. The bad actor can now reset the password for the victim's online banking account and receive the OTP on the replacement phone, thus gaining access to the victim's bank account. Often, once the bad actor has access to the phone number, they can gain access to the victim's email giving them access to a second 2FA vector as OTP may be sent via email as well as SMS. This can often give the bad actor access to many accounts of the victim. Banking access can be used to steal money. Access to email, photos or messaging apps can be used for identity theft or to extort victims threatening the release of private information.

There are some security protections in place to help prevent this type of attack, including authentication methods employed by customer care, for example security questions in person, online, or over the phone, as mentioned above. Often answers to these security questions can be gleaned from the victim's social media accounts or through other social engineering methods. Security questions alone cannot prevent wireless account takeovers. Other layers of security are needed.

Wireless devices report their location to their wireless providers regularly and necessarily for the provision of the wireless services. For example, when a wireless device requests to place a call, it will create a request and send it to the wireless provider. Included in the call request is a report of the wireless device's current location. This location data is used at the Gateway Mobile Location Center (GMLC) to help determine the correct routing of the call request to reach the destination of the call. This location data is also stored in a database with much more information from and about all wireless devices connecting to the wireless provider's network. The stored information includes information on which access nodes a wireless device connects to and when, wireless device usage statistics, and much more. This historical information is maintained for troubleshooting, billing and other uses.

A dominant location may be determined by querying a database containing the historical information. The dominant location is where the wireless device spends the most time, for example a dominant location could be the user's work location. The dominant location may also be determined based on where the wireless device is used most in a particular predetermined time interval. For example, the wireless device may spend the most time at the home of user but goes unused while the user is asleep. The wireless device spends less time at the user's work location but is used more while it is there. In this example, the user's work location may be the dominant location. The dominant location may be determined by either of these methods or any other useful method. The dominant location may be calculated based on location data over the last month, year or any other useful period of time.

A home location of the wireless device may be determined by querying an account database for the home address or billing address of the account holder. The home location may also be determined by calculating where the wireless device spends the most time not being used, for example while the user of the wireless device sleeps. When calculated, the home location may be calculated based on location data over the last month, year or any other useful period of time. The home location may be determined by either of these methods or any other useful method.

A wireless provider may have a number of retail store locations. They know the locations of their retail stores and may store that information in a database. A person may request a transaction at a store location and thus their location would be known. However, a person requesting a transaction via the provider's customer service portal or customer care line would need another method of indicating their location. There are many known methods of determining the location of someone accessing a website. For example, the IP address of the device accessing the website may be used. Caller ID may be used to determine the phone number of a caller to customer care which may then be used to look up their location. For example, if the caller is on a different wireless device than the one tied to the account, but it is still serviced by the same provider, the provider will have access to the location. In another example, the address of a landline may be available in a directory service.

Once these location data points are known, they can be analyzed and used in calculations to provide a risk score. The risk score may indicate a likelihood that a person is attempting to improperly access the wireless account connected to the wireless device. The distance between the current location of the wireless device and the store location may be calculated. The distance between the current location of the wireless device and the person requesting the account transaction may be calculated. The distance between the current location of the wireless device and the dominant location of the wireless device may be calculated. The distance between the current location of the wireless device and the home location may be calculated. The distance between the store location and the dominant location of the wireless device may be calculated. The distance between the store location and the home location may be calculated. The distance between the person requesting the transaction and the dominant location of the wireless device may be calculated. The distance between the person requesting the transaction and the home location may be calculated. Any combination of these distances may be used to determine a risk score. Providers may choose which distances, which threshold values of distances, and how to calculate the risk score based on the selected distances. Risk scores may be applied in two stages. For example, a risk score above a first threshold but below a second threshold may be cause for concern and trigger secondary authorization. Secondary authorization may include approval by a store manager or customer care manager, or some additional authentication by way of two-factor authentication (2FA). If the risk score is above the second threshold, higher than the first threshold, the transaction may be denied. Some real-world examples are explained below.

When a person goes into a retail store of the provider seeking to buy and/or activate a new wireless device to replace an existing wireless device, a security check may be implemented. The distance between the store and the existing wireless device may be calculated. The distance between the store and the dominant location may be calculated. The distance between the store and the home location may be calculated. Any combination of these distances may be used to calculate a risk score. Unless the existing wireless device has been lost or stolen, it should be at the store location. There is a high likelihood that the store location will be within a reasonable travel distance from either the home location, dominant location or both. If these distances are not inline with expected ranges, the risk score will be higher. If sufficiently high, the transaction request may require approval by a store manager or may require some form of 2FA. For example, the person making the request may need to present identification matching the account holder. If the risk score is even higher, the transaction may be denied.

When a person requests to activate a new wireless device replacing an existing wireless device via the provider's website, a security check may be required. The distance between the existing wireless device and the person making the request may be calculated. The distance between the existing wireless device and the dominant location may be calculated. The distance between the existing wireless device and the home location may be calculated. The distance between the person requesting the transaction and the home location may be calculated. The distance between the person requesting the transaction and the dominant location may be calculated. Any combination of these distances may be used to calculate a risk score. It may be reasonable to expect that the person requesting the transaction would be near at least one of the dominant location or the home location, for example. If any of these distances are out of line with expected results, the risk score may be higher. If sufficiently high, the transaction request may require some form of 2FA. If the risk score is even higher, the transaction may be denied.

When a person requests to activate a new wireless device replacing an existing wireless device via the provider's customer care phone line, a security check may be required. The distance between the existing wireless device and the dominant location may be calculated. The distance between the existing wireless device and the home location may be calculated. The distance between the existing wireless device and the person making the request may be calculated. The distance between the person requesting the transaction and the home location may be calculated. The distance between the person requesting the transaction and the dominant location may be calculated. Any combination of these distances may be used to calculate a risk score. It may be reasonable to expect that the person requesting the transaction would be near at least one of the dominant location or the home location, for example. If any of these distances are out of line with expected results, the risk score may be higher. If sufficiently high, the transaction request may require some form of 2FA. If the risk score is even higher, the transaction may be denied.

Other types of transactions may benefit from the security checks as well. For example, a person requesting access to the account details, call logs, message history, or adding/removing/replacing devices or lines on the account may all require the security checks described herein. The above examples describe some of the scenarios where using multiple location data points may be helpful in identifying risky transactions. The list of examples is neither exhaustive nor limiting.

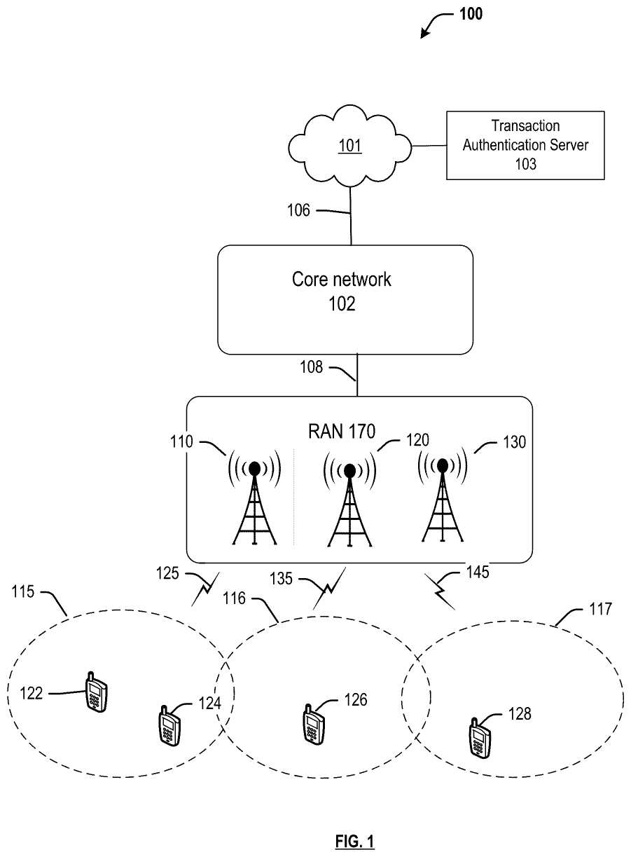

FIG. 1 depicts an exemplary system 100 for wireless communication, in accordance with the disclosed embodiments. System 100 may include a communication network 101, core network 102, and a radio access network (RAN) 170 including access nodes 110, 120, and 130. The RAN 170 may include other devices and additional access nodes. Although three access nodes are shown, any number of access nodes may be included.

System 100 also includes multiple wireless devices 122, 124, 126, and 128, which may be end-user wireless devices and may operate within one or more coverage areas 115, 116, and 117. The wireless devices 122, 124, 126, 128 communicate with access nodes 110, 120, and/or 130 within the RAN 170 over communication links 125, 135, and 145, which may for example be 4G or 5G communication links.

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless devices 122, 124, 126, 128. Wireless network protocols can comprise Fourth Generation mobile networks or wireless systems (4G or 4G LTE) or Fifth Generation mobile networks or wireless systems (5G). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

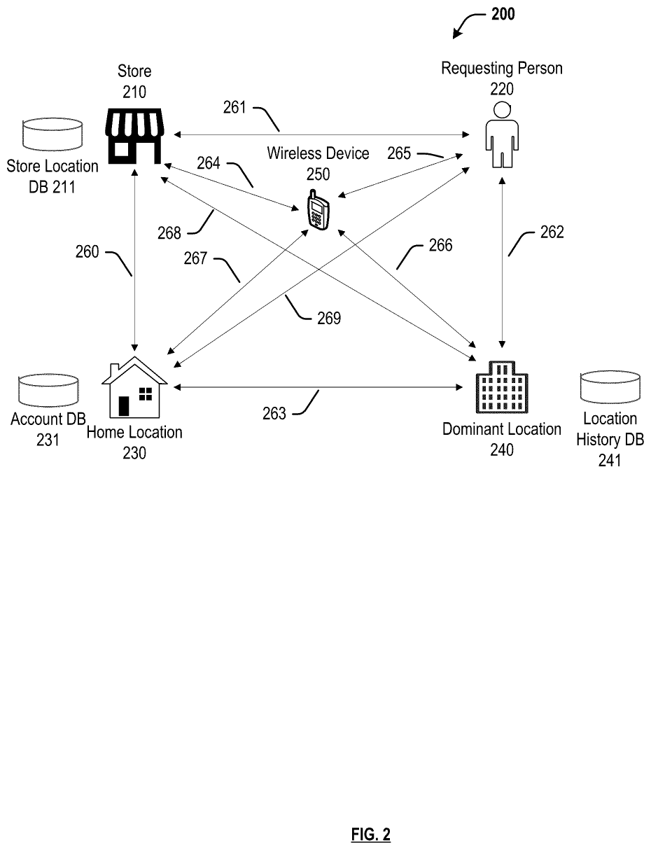

Transaction Authentication Server 103 may be located at any point within the wireless provider's network and will be explained further in relation to FIG. 2. The core network 102 includes a number of server functions necessary for the operation of a wireless network but are omitted in FIG. 1 for clarity. The core network 102 may be separated into user plane functions and control plane functions. The user plane accesses a data network, such as network 101, and performs operations such as packet routing and forwarding, packet inspection, policy enforcement for the user plane, quality of service (QOS) handling, etc. The control plane handles radio-specific functionality that depends on the idle or connected states of the wireless devices 122, 124, 126, and 128.

Communication links 106 and 108 can use various communication media, such as air, space, metal, optical fiber, or some other signal propagation path-including combinations thereof. Communication links 106 and 108 can be wired or wireless and use various communication protocols such as Internet, Internet protocol (IP), local-area network (LAN), S1, optical networking, hybrid fiber coax (HFC), telephony, T1, or some other communication format-including combinations, improvements, or variations thereof. Wireless communication links may use electromagnetic waves in the radio frequency (RF), microwave, infrared (IR), or other wavelength ranges, and may use a suitable communication protocol, including 4G including 4G NR or 4G Advanced, 6G, NTN, or combinations thereof.

Communication links 106 and 108 can be direct links or might include various equipment, intermediate components, systems, and networks, such as a cell site router, etc. Communication links 106 and 108 may comprise many different signals sharing the same link.

The RAN 170 may include various access network systems and devices such as access nodes 110, 120, 130. The RAN 170 is disposed between the core network 102 and the end-user wireless devices 122, 124, 126, 128. Components of the RAN 170 may communicate directly with the core network 102 and others may communicate directly with the end user wireless devices 122, 124, 126, 128. The RAN 170 may provide services from the core network 102 to the end-user wireless devices 122, 124, 126, and 128.

The RAN 170 includes multiple access nodes (or base stations) 110, 120, 130, which may include one or more access nodes communicating with the plurality of end-user wireless devices 122, 124, 126, 128. It should be understood that the disclosed technology may also be applied to communication between an end-user wireless device and other network resources, such as relay nodes, controller nodes, antennas, etc. The RAN 170 may further comprise a non-terrestrial network (NTN) serving the multiple UEs by a radio frequency transmission provided by utilizing orbiting satellites that may be in communication with access nodes of a terrestrial network (TN). The satellites may include geosynchronous equatorial orbit (GEO) satellites, Medium Earth Orbit (MEO) satellites, and low Earth orbit (LEO) satellites. The NTN may include NTN nodes that are not stationed on the ground.

Access nodes 110, 120, 130 can be, for example, standard access nodes such as a macro-cell access node, a base transceiver station, a radio base station, an evolved NodeB (or eNodeB) in 4G or 4G LTE, a next generation NodeB (or gNodeB) in 5G New Radio (“5G NR”), or the like. In additional embodiments, access nodes may comprise two co-located cells, or antenna/transceiver combinations that are mounted on the same structure. Alternatively, access nodes 110, 120, 130 may comprise a short range, low power, small-cell access node such as a microcell access node, a picocell access node, a femtocell access node. Access nodes 110, 120, 130 can be configured to deploy one or more different carriers, utilizing one or more RATs. Any other combination of access nodes and carriers deployed therefrom may be evident to those having ordinary skill in the art in light of this disclosure.

The access nodes 110, 120, 130, servers in the IMS 103, the GMLC 104 and STI-AS 105 may comprise a processor and associated circuitry to execute or direct the execution of computer-readable instructions. They may retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

The wireless devices 122, 124, 126, and 128 may include any wireless device included in a wireless network. For example, the term “wireless device” may include a relay node, which may communicate with an access node. The term “wireless device” may also include an end-user wireless device, which may communicate with the access node through a relay node. The term “wireless device” may further include an end-user wireless device that communicates with the access node directly without being relayed by a relay node. Wireless devices 122, 124, 126, and 128 may be any device, system, combination of devices, or other such communication platform capable of communicating wirelessly with access node 110, 120, and 130 using one or more frequency bands and wireless carriers deployed therefrom. Each of wireless devices 122, 124, 126, and 128, may be, for example, a mobile phone, a wireless phone, a wireless modem, a personal digital assistant (PDA), a voice over internet protocol (VoIP) phone, a voice over packet (VOP) phone, or a soft phone, a wearable device, an internet of things (IoT) device, as well as other types of devices or systems that can send and receive audio or data. The wireless devices 122, 124, 126 128 may be or include high power wireless devices or standard power wireless devices.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork (including the Internet). Communication system 100 may be capable of communicating signals and carrying data, for example, to support voice, push-to-talk, broadcast video, and data communications by end-user wireless devices 122, 124, 126, and 128.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g., between the radio access network 170 and the core network 102.

FIG. 2 illustrates an example operating environment for identifying risky transactions using multiple location data points. A store 210, a requesting person 220, a home location 230, a dominant location 240, and a wireless device 250 are shown. Wireless device 250 may be an instance of wireless devices 122, 124, 126, and 128 from FIG. 1.

In operation, a system for identifying risky transactions using multiple data points may include a transaction authentication server, such as transaction authentication server 103 from FIG. 1. The transaction authentication server may include one or more electronic processors configured to perform operations. The operations may include receiving a request to perform a transaction with an account of a wireless device. The request may come from a requesting person 220 walking into a retail store 210, calling a customer care line, or accessing a website of the wireless provider. The operations may include determining a risk score for the transaction based in part on some or combination of the following distance calculations.

The distance between home location 230 and store 210, labeled 260.

The distance between store 210 and requesting person 220, labeled 261.

The distance between requesting person 220 and dominant location 240, labeled 262.

The distance between dominant location 240 and home location 230, labeled 263.

The distance between wireless device 250 and store 210, labeled 264.

The distance between wireless device 250 and requesting person 220, labeled 265.

The distance between wireless device 250 and dominant location 240, labeled 266.

The distance between wireless device 250 and home location 230, labeled 267.

The distance between store 210 and dominant location 240, labeled 268.

The distance between requesting person 220 and home location 230, labeled 269.

In one scenario, the distance score may be calculated by assigning a first score value when a particular distance is less than a first distance threshold, assigning a second score value when the particular distance is equal to or greater than the first distance threshold but less than a second distance threshold, assigning a third score value when the particular distance is equal to or greater than the second distance threshold but less than a third distance threshold, and so on and so forth. The score values assigned to two or more of the distances may be further added together to calculate a risk score that is compared to one or more risk score thresholds. In some instances, the different types of distances may have score values of identical or different score scales. For example, the distance between wireless device 250 and home location 210 may be assigned values between 1-20 depending on the magnitude of the distance, while the distance between store 210 and the dominant location 240 may be assigned values between 1-10 depending on the magnitude of the distance. In another scenario, two or more distances may be added together to obtain a total distance. This total distance is then converted into a risk score based on a distance-to-risk score value correlation table. For example, a total distance that is less than a first distance threshold is assigned a first risk score, a total distance that is equal to or greater than the first distance threshold but less than a second distance threshold is assigned a second risk score, a total distance that is equal to or greater than the second distance threshold but less than a third distance threshold is assigned a third risk score, and so on and so forth. The assigned risk score may then be compared to one or more risk score thresholds. Accordingly, in some embodiments, each of the at least two distances may be mathematically converted into a corresponding score value or a portion of a corresponding risk score based on a magnitude of the distance for the generation of a risk score.

The location of store 210 may be determined by querying a store location database 211 maintained by the wireless provider. Home location 230 may be determined by querying an account database 231 that includes the home address of the account holder, or by calculating where the wireless device spends the most time not being used, for example while the user of the wireless device sleeps, for example. Other useful methods of determining the home location 230 may be used. Dominant location 240 may be determined by calculating where the wireless device spends the most time, for example a dominant location 240 could be the user's work location. Alternatively, the dominant location 240 may also be calculated based on where the wireless device is used most. Either of these calculations may be completed using information retrieved from a location history database 241 maintained by the wireless provider. Other useful methods of determining the dominant location 240 may be used. The location of requesting person 220 may be determined using the IP address of the device accessing the provider's website, using Caller ID of the device calling customer care, or any other useful method of determining the location of requesting person 220.

Other ways to determine location for wireless device 250 may utilize GPS, antenna patterns, location based services (LBS), such a triangulation, communication patterns, Bluetooth, Wifi and combinations thereof to determine the location of wireless device 250. Multiple towers are used to track the phone's location by measuring the time delay that a signal takes to return back to the towers from the phone.

GPS utilizes satellite location and triangulation to determine the coordinates of the wireless device 250. Location of wireless device may also be determined based on wi-fi location, measuring power levels and antenna patterns of the wireless device 250 communicating wirelessly with one or more access nodes.

Once the risk score is determined, it may be compared to a first risk score threshold. If the risk score is above the first risk score threshold, secondary authorization may be required to complete the requested transaction. Examples of secondary authorization include store manager approval, approval by a customer care manager, and additional authentication by way of two-factor authentication. If the risk score is above a second risk score threshold, higher than the first risk score threshold, the transaction may be denied. If the risk score is at or below the first risk score threshold, then no secondary authorization is required before the requested transaction is performed.

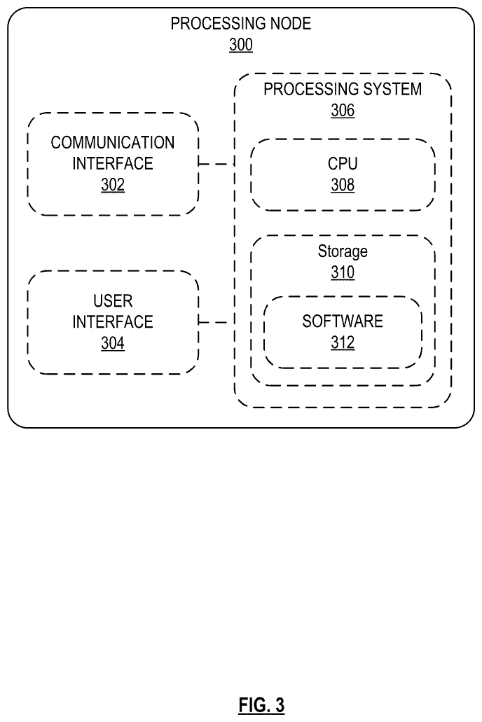

FIG. 3 depicts an example processing node 300, which may be configured to perform the methods and operations disclosed herein for identifying risky transactions using multiple location data points. The processing node 300 includes a communication interface 302, user interface 304, and processing system 306 in communication with communication interface 302 and user interface 304. Communication interface 302 may include hardware components, such as network communication ports, devices, routers, wires, antenna, transceivers, etc. User interface 304 may include hardware components, such as touch screens, buttons, displays, speakers, etc.

Processing system 306 includes a processor 308, storage 310, which can comprise a disk drive, flash drive, memory circuitry, or other memory device including, for example, a buffer. Storage 310 can store software 312 which is used in the operation of the processing node 300. Software 312 may include computer programs, firmware, or some other form of machine-readable instructions, including an operating system, utilities, drivers, network interfaces, applications, or some other type of software. Processing system 306 may include a processor 308 and other circuitry to retrieve and execute software 312 from storage 310, which may be internal or external to the processing system 306. Processing node 300 may further include other components such as a power management unit, a control interface unit, etc., which are omitted for clarity. Communication interface 302 permits processing node 300 to communicate with other network elements. User interface 304 permits the configuration and control of the operation of processing node 300. Processing node 300 may be included in various elements of the wireless network including a transaction authentication server.

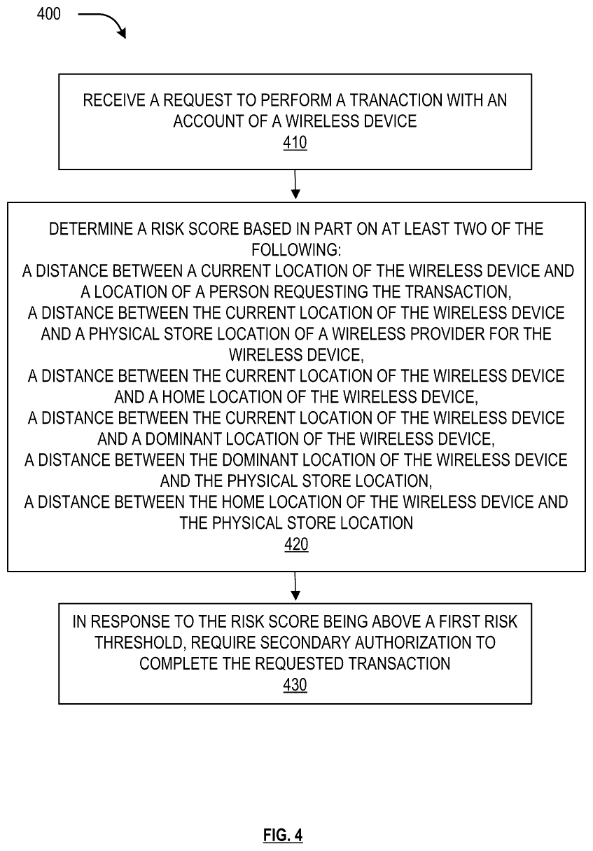

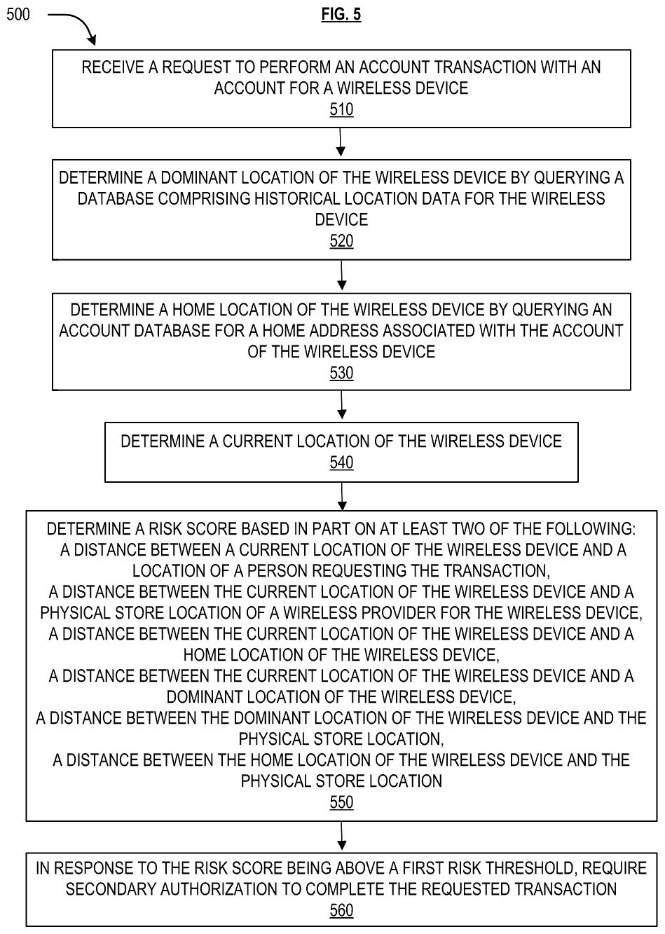

In exemplary embodiments, software 212 may include instructions for the operations disclosed above with respect to FIG. 2 or the methods disclosed below with respect to FIGS. 4 and 5.

FIG. 4 illustrates an exemplary method 400 of identifying risky transactions using multiple location data points. Method 400 may be performed by any suitable combination of processors discussed herein, for example a processor contained in a transaction authentication server.

Method 400 begins in step 410 where a request to perform a transaction with an account of a wireless device is received. A transaction may include requesting access to the account details, call logs, message history, or adding/removing/replacing devices or lines on the account, for example. Method 400 continues in step 420 where a risk score is determined based in part on at least two for the following:

A distance between a current location of the wireless device and a location of a person requesting the transaction.

A distance between the current location of the wireless device and a physical store location of a wireless provider for the wireless device.

A distance between the current location of the wireless device and a home location of the wireless device.

A distance between the current location of the wireless device and a dominant location of the wireless device.

A distance between the dominant location of the wireless device and the physical store location.

A distance between the home location of the wireless device and the physical store location.

Method 400 continues in step 430 where, in response to the risk score being above a first risk score threshold, secondary authorization is required to complete the requested transaction. Method 400 may include the optional step of, in response to the risk score being above a second risk score threshold higher than the first risk score threshold, denying the requested transaction. Secondary authorization modes may include store manager approval, approval by a customer care manager, and additional authentication by way of two-factor authentication. If the risk score is at or below the first risk score threshold, then no secondary authorization is required before the requested transaction is performed.

FIG. 5 illustrates an exemplary method 500 of identifying risky transactions using multiple location data points. Method 500 may be performed by any suitable combination of processors discussed herein, for example a processor contained in a transaction authentication server.

Method 500 begins in step 510 where a request to perform an account transaction with an account of a wireless device is received. An account transaction may include requesting access to the account details, call logs, message history, or adding/removing/replacing devices or lines on the account, for example.

Method 500 continues in step 520 where a dominant location of the wireless device is determined by querying a database comprising historical location data for the wireless device. Method 500 continues in step 530 where a home location of the wireless device is determined by querying a database for a home address associated with the account of the wireless device. Method 500 continues in step 540 where a current location of the wireless device is determined. Method 500 continues in step 550 where a risk score is determined based in part on at least two for the following:

A distance between a current location of the wireless device and a location of a person requesting the transaction.

A distance between the current location of the wireless device and a physical store location of a wireless provider for the wireless device.

A distance between the current location of the wireless device and a home location of the wireless device.

A distance between the current location of the wireless device and a dominant location of the wireless device.

A distance between the dominant location of the wireless device and the physical store location.

A distance between the home location of the wireless device and the physical store location.

Method 500 continues in step 560 where, in response to the risk score being above a first risk score threshold, secondary authorization is required to complete the requested transaction. Method 500 may include the optional step of, in response to the risk score being above a second risk score threshold higher than the first risk score threshold, denying the requested transaction. Secondary authorization modes may include store manager approval, approval by call center team lead, and additional authentication by way of two-factor authentication. If the risk score is at or below the first risk score threshold, then no secondary authorization is required before the requested transaction is performed.

In some embodiments, methods 400 and 500 may include additional steps or operations. Furthermore, the methods may include steps shown in each of the other methods. As one of ordinary skill in the art would understand, the methods of 400 and 500 may be integrated in any useful manner and the steps may be performed in any useful sequence.

The exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method, the method comprising:
receiving a request to perform an account transaction with an account of a wireless device;
determining a risk score for the transaction based in part on at least two of the following:
a distance between a current location of the wireless device and a location of a person requesting the transaction,
a distance between the current location of the wireless device and a physical store location of a wireless provider for the wireless device,
a distance between the current location of the wireless device and a home location of the wireless device,
a distance between the current location of the wireless device and a dominant location of the wireless device,
a distance between the dominant location of the wireless device and the physical store location,
a distance between the home location and the physical store location; and
in response to the risk score being above a first risk score threshold, requiring secondary authorization to complete the account transaction.

2. The method of claim 1, wherein the secondary authorization comprises at least one of: store manager approval, approval by a customer care manager, and additional authentication by way of two-factor authentication.

3. The method of claim 1, the method further comprising:
in response to the risk score being above a second risk score threshold higher than the first risk score threshold, denying the account transaction.

4. The method of claim 1, wherein the physical store location is determined by querying a database comprising known store locations for the wireless provider of the wireless device.

5. The method of claim 1, wherein the home location of the account of the wireless device comprises a billing location of the account of the wireless device.

6. The method of claim 1, wherein the location of the person requesting the transaction is determined by using at least one of an IP address of a device accessing a customer service portal of a wireless provider, and a Caller ID of a device calling a customer service phone line of the wireless provider.

7. The method of claim 1, wherein the dominant location of the wireless device comprises a location where the wireless device is most often used; and wherein the method further comprises:
determining the current location of the wireless device by querying a database comprising location information of wireless devices served by the wireless provider.

8. The method of claim 1, wherein the account transaction comprises at least one of accessing information of the account, changing information of the account, adding a new wireless device to the account, and changing a SIM card for the wireless device.

9. A system, the system comprising:
a transaction authentication server, including at least one electronic processor configured for executing instructions to perform operations including:
receiving a request to perform an account transaction with an account of a wireless device;
determining a risk score for the transaction based in part on at least two of the following:
a distance between a current location of the wireless device and a location of a person requesting the transaction,
a distance between the current location of the wireless device and a physical store location of a wireless provider for the wireless device,
a distance between the current location of the wireless device and a home location of the wireless device,
a distance between the current location of the wireless device and a dominant location of the wireless device,
a distance between the dominant location of the wireless device and the physical store location,
a distance between the home location and the physical store location; and
in response to the risk score being above a first risk score threshold, requiring secondary authorization to complete the account transaction.

10. The system of claim 9, wherein the secondary authorization comprises at least one of: store manager approval, approval by a customer care manager, and additional authentication by way of two-factor authentication.

11. The system of claim 9, the operations further comprising:
in response to the risk score being above a second risk score threshold higher than the first risk score threshold, denying the account transaction.

12. The system of claim 9, wherein the physical store location is determined by querying a database of known store locations for the wireless provider of the wireless device.

13. The system of claim 9, wherein the home location of the account of the wireless device comprises a billing location of the account of the wireless device.

14. The system of claim 9, wherein the location of the person requesting the transaction is determined by using at least one of an IP address of a device accessing a customer service portal of a wireless provider, and a Caller ID of a device calling a customer service phone line of the wireless provider.

15. The system of claim 9, wherein the dominant location of the wireless device comprises a location where the wireless device is most often used, and wherein the operations further comprise:
determining the current location of the wireless device by querying a database comprising location information of wireless devices served by the wireless provider.

16. The system of claim 9, wherein the account transaction comprises at least one of accessing information of the account, changing information of the account, adding a new wireless device to the account, and changing a SIM card for the wireless device.

17. A method, the method comprising:
receiving a request to perform an account transaction with an account for a wireless device;
determining a dominant location of the wireless device by querying a database comprising historical location data for the wireless device;
determining a home location of the wireless device by querying an account database for a home address associated with the account for the wireless device;
determining a current location of the wireless device;
determining a risk score for the account transaction based in part on at least two of the following:
a distance between the current location of the wireless device and a location of a person requesting the account transaction,
a distance between the current location of the wireless device and a physical store location of a wireless provider for the wireless device,
a distance between the current location of the wireless device and the home location of the wireless device,
a distance between the current location of the wireless device and the dominant location of the wireless device,
a distance between the dominant location of the wireless device and the physical store location,
a distance between the home location and the physical store location; and
in response to the risk score being above a first risk score threshold, requiring secondary authorization to complete the account transaction.

18. The method of claim 17, wherein the secondary authorization comprises at least one of: store manager approval, approval by a customer care manager, and additional authentication by way of two-factor authentication.

19. The method of claim 17, the method further comprising:
in response to the risk score being above a second risk score threshold higher than the first risk score threshold, denying the account transaction.

20. The method of claim 17, wherein the account transaction comprises at least one of accessing information of the account, changing information of the account, adding a new wireless device to the account, and changing a SIM card for the wireless device.
